(19) United States
(12) Patent Application Publication
(10) Pub. No.: US 2026/0094903 A1
(43) Pub. Date: Apr. 2, 2026

(54) BATTERY AND METHOD OF MANUFACTURING SAME

(71) Applicant: SAMSUNG SDI CO., LTD., Yongin-si (KR)

(72) Inventor: Taewoong Jang, Yongin-si (KR)

(21) Appl. No.: 19/063,625

(22) Filed: Feb. 26, 2025

(30) Foreign Application Priority Data
Oct. 2, 2024 (KR) 10-2024-0134050

(51) Int. Cl. H01M 50/152; H01M 4/38; H01M 10/0525; H01M 10/0587; H01M 50/107; H01M 50/593

(52) U.S. Cl. CPC H01M 50/152; H01M 4/386; H01M 10/0525; H01M 10/0587; H01M 50/107; H01M 50/593

(57) ABSTRACT

A battery includes a wound electrode assembly having a first electrode, a second electrode, and a separator between the first electrode and the second electrode, a case accommodating the electrode assembly, the case including an opening on one side, a cap assembly sealing the opening, an insulating sheet between the cap assembly and the electrode assembly, and a lithium metal layer on the insulating sheet facing the cap assembly.

### CROSS-REFERENCE TO RELATED APPLICATION

The present application claims priority to and the benefit of Korean Application No. 10-2024-0134050, filed on Oct. 2, 2024, in the Korean Intellectual Property Office, the entire disclosure of which is incorporated by reference herein.

### BACKGROUND

### 1. Field

Embodiments relate to a battery and a method of manufacturing the battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments are directed to a battery, having a wound electrode assembly including a first electrode, a second electrode, and a separator between the first electrode and the second electrode, a case accommodating the electrode assembly, the case including an opening on one side, a cap assembly sealing the opening, an insulating sheet between the cap assembly and the electrode assembly, and a lithium metal layer on the insulating sheet facing the cap assembly.

An electrode tab may connect the first electrode to the lithium metal layer.

The battery may be configured so that lithium ions are released from the lithium metal layer when a current is applied to the first electrode.

The battery may be configured so that the released lithium ions are stored inside the second electrode.

The insulating sheet may include a material having a porous structure, and the battery may be configured so that the released lithium ions move through the insulating sheet.

The insulating sheet may include a body portion having a first surface and a second surface in opposing configuration, the lithium metal layer may be on the first surface and a protrusion may extend from the second surface.

The electrode assembly may include a through hole in a core thereof, and the protrusion may extend into the through hole.

The protrusion may stabilize the insulating sheet relative to the electrode assembly.

A diameter of the protrusion may be less than a diameter of the through hole.

A vertical length of the protrusion may be less than a vertical length of the through hole.

A radius of the lithium metal layer may be less than a radius of the insulating sheet.

A radius difference between the lithium metal layer and the insulating sheet may be 100 μm or more.

The insulating sheet may include a body portion having the lithium metal layer on a surface thereof, and a sidewall portion extending along an outer circumference of the body portion and surrounding the lithium metal layer.

The sidewall portion may extend above the lithium metal layer.

A thickness of the lithium metal layer may be 5 μm to 250 μm.

The second electrode may include an active material layer including a silicon-based material.

Embodiments are directed to a method of manufacturing a battery, the method include preparing an electrode assembly by winding a first electrode, a second electrode, and a separator, the separator being between the first electrode and the second electrode, preparing a case with an opening formed on one side thereof, inserting the electrode assembly into the case through the opening, positioning an insulating sheet on one side of the electrode assembly, the one side of the electrode assembly facing the opening, and sealing the opening by joining a cap assembly to the case, wherein a lithium metal layer is positioned on a surface of the insulating sheet facing the cap assembly.

The method may further include connecting the first electrode to the lithium metal layer using an electrode tab and thereafter sealing the opening.

After sealing the opening, an electrical current may be applied to the first electrode to release lithium ions from the lithium metal layer.

The method may further include providing the insulating sheet with a body portion having a first surface and a second surface in opposing configuration, providing the lithium metal layer on the first surface, and providing a protrusion extending from the second surface, providing the electrode assembly with a core having a through hole, providing a through hole in a core of the electrode assembly, and inserting the protrusion into the through hole.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view showing an example of a battery according to an embodiment of the present disclosure;

FIG. 2 illustrates a perspective view showing an example in which a lithium metal layer is positioned on an insulating sheet according to an embodiment of the present disclosure;

FIG. 3 illustrates a cross-sectional view showing an example in which a lithium metal layer is positioned on an insulating sheet according to an embodiment of the present disclosure;

FIG. 4 illustrates a perspective view showing an example in which a lithium metal layer is positioned on an insulating sheet according to another embodiment of the present disclosure;

FIG. 5 illustrates a cross-sectional view showing an example in which a lithium metal layer is positioned on an insulating sheet according to another embodiment of the present disclosure;

FIG. 6 illustrates a perspective view showing an example in which a lithium metal layer is positioned on an insulating sheet according to another embodiment of the present disclosure;

FIG. 7 illustrates a cross-sectional view showing an example in which a lithium metal layer is positioned on an insulating sheet according to another embodiment of the present disclosure;

FIG. 8 illustrates a perspective view showing an insulating sheet according to an embodiment of the present disclosure;

FIG. 9 illustrates an example of an electrode assembly in which an insulating sheet is positioned according to a comparative example;

FIG. 10 illustrates an example of an electrode assembly in which an insulating sheet is positioned according to an embodiment of the present disclosure; and

FIG. 11 illustrates a flowchart for describing a method of manufacturing a battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes, thicknesses, relative sizes, and relative thicknesses of regions shown in the drawings may be exaggerated for clarity of description. That is, the sizes shown in the drawings are only for convenience of understanding and are not limited thereto. In addition, the same reference numerals denote the same elements throughout the specification.

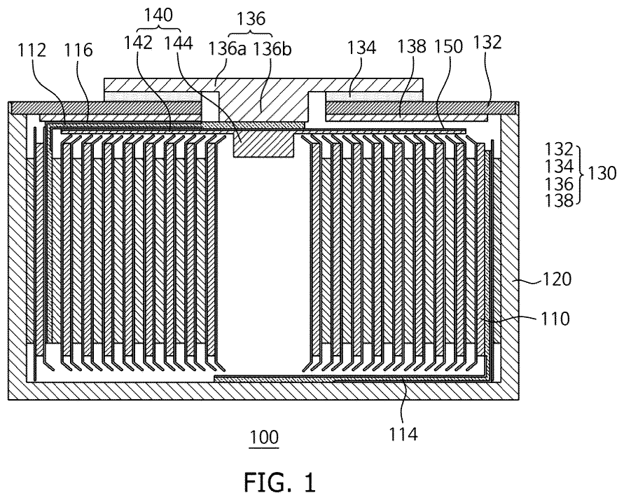

FIG. 1 illustrates a cross-sectional view showing an example of a battery 100 according to an embodiment of the present disclosure. FIG. 1 illustrates a cross-sectional view showing a structure in which the battery 100 having an approximately cylindrical shape is cut in the height direction along a line crossing the center of the battery 100. The battery 100 may include, e.g., an electrode assembly 110, a case 120, a cap assembly 130, an insulating sheet 140, and a lithium metal layer 150.

The battery 100 may be, e.g., a coin-type or button-type battery. In an implementation, the battery 100 may have a cylindrical shape. However, in an implementation, the battery 100 may be, e.g., a cylindrical, prismatic, or pouch-type battery. In an implementation, the battery 100 may be a secondary battery capable of charging and discharging.

The electrode assembly 110 may include, e.g., a first electrode, a second electrode, and a separator. In an implementation, the electrode assembly 110 may be configured by winding the first electrode, the second electrode, and the separator positioned between the first electrode and the second electrode. For example, the electrode assembly 110 may be a wound electrode assembly. In an implementation, a through hole may be formed in a core, e.g., a central portion, of the electrode assembly 110.

The first electrode may include, e.g., a first substrate and a first active material layer on the first substrate. A first electrode tab 112 may extend outward from a first uncoated portion of the first substrate where the first active material layer is not located, and the first electrode tab 112 may be electrically connected to a terminal plate 136 of the cap assembly 130.

In an embodiment, the first electrode may function as a positive electrode. In this case, the first substrate may include, e.g., aluminum foil, and the first active material layer may include, e.g., a transition metal oxide.

The second electrode may include, e.g., a second substrate and a second active material layer located on the second substrate. A second electrode tab 114 may extend outward from a second uncoated portion of the second substrate where the second active material layer is not located, and the second electrode tab 114 may be electrically connected to the case 120. The first electrode tab 112 and the second electrode tab 114 may extend in opposite directions.

In an embodiment, the second electrode may function as a negative electrode. In this case, the second substrate may include, e.g., copper foil or nickel foil, and the second active material layer may include, e.g., a silicon-based material. Because the second active material layer may include a silicon-based material, the energy density of the battery 100 may be increased, compared to a case where the second active material includes a carbon-based material (e.g., graphite).

In an embodiment, each of the first electrode tab 112 and the second electrode tab 114 may be covered with a cover tape 116. The cover tape 116 may include, e.g., an insulating material. The insulating material may provide electrical insulation to prevent current, e.g., electrical current, from passing therethrough. The cover tape 116 may prevent a short circuit from occurring in the first electrode tab 112 and the second electrode tab 114.

The separator may function to prevent a short circuit between the first electrode and the second electrode while allowing movement of lithium ions. The separator may include, e.g., polyethylene film, polypropylene film, polyethylene-polypropylene film, or the like.

The case 120 may accommodate the electrode assembly 110 and an electrolyte. The case 120 may have a substantially cylindrical shape. In an implementation, the case 120 may have various shapes, e.g., a prismatic shape or a pouch shape. In some embodiments, the case 120 may include metal, e.g., aluminum, an aluminum alloy, nickel-plated steel, or stainless steel, or a laminated film or plastic that constitutes a pouch.

The case 120 may accommodate the electrode assembly 110. The case 120 may include an opening on one side. The electrode assembly 110 may be inserted into the case 120 through the opening. Thereafter, the opening of the case 120 may be closed by the cap assembly 130. For example, the cap assembly may cover and seal the opening of the case 120. The cap assembly 130 may be joined to one side of the case 120.

The cap assembly 130 may include, e.g., a cap plate 132, an insulating layer 134, a terminal plate 136, and an insulating member 138. The cap plate 132 may cover the opening of the case 120. The cap plate 132 may be joined to an end of the side surface of the case 120 corresponding to the side surface of the opening.

An insertion hole may be formed in the cap plate 132. In some embodiments, the insertion hole may be formed at the central portion of the cap plate 132. The terminal plate 136 may be inserted into the insertion hole and the terminal plate 136 may be joined to the cap plate 132. The terminal plate 136 may include, e.g., a body portion 136a and an insertion portion 136b protruding from the body portion 136a. The insertion portion 136b of the terminal plate 136 may be inserted into the insertion hole of the cap plate 132. In an implementation, the insertion portion 136b of the terminal plate 136 may be connected in contact with the first electrode tab 112. Referring to FIG. 1, the cap assembly 130 to which the terminal plate 136 is joined may be joined to the case 120 so that the insertion portion 136b faces the electrode assembly 110.

The insulating layer 134 may be between the terminal plate 136 and the cap plate 132. The insulating layer 134 may have adhesive strength, e.g., the insulating layer 134 may include an adhesive, and thus may join the terminal plate 136 to the cap plate 132. The insulating layer 134 may include, e.g., an insulating material and may electrically insulate the terminal plate 136 and the cap plate 132 from each other.

In an embodiment, the insulating member 138 may be on the bottom surface of the cap plate 132. The top surface of the cap plate 132 may face the body portion 136a of the terminal plate 136, and the bottom surface of the cap plate 132 may face the electrode assembly 110. The insulating member 138 may include, e.g., an insulating material and may insulate between, e.g., be between, the cap plate 132 and the electrode assembly 110 or between the cap plate 132 and the first electrode tab 112.

The insulating sheet 140 may be between the cap assembly 130 and the electrode assembly 110. In an implementation, the insulating sheet 140 may be between the first electrode tab 112 and the electrode assembly 110. In an implementation, the insulating sheet 140 may include, e.g., an insulating material, and the insulating sheet 140 may therefore help prevent a short circuit between the cap assembly 130 and the electrode assembly 110. In some embodiments, the insulating sheet 140 may help prevent a short circuit between the first electrode tab 112 and the electrode assembly 110.

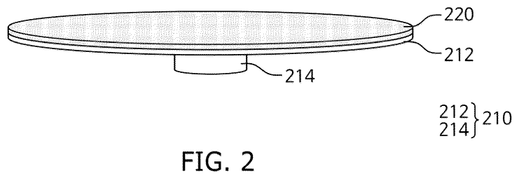

The insulating sheet 140 may include, e.g., a body portion 142 and a protrusion 144 extending from the body portion 142. The body portion 142 may be on the top surface of the electrode assembly 110. The top surface of the electrode assembly 110 may refer to one surface of the electrode assembly 110 facing the cap assembly 130. The protrusion 144 may extend from one surface of the body portion 142 facing the top surface of the electrode assembly 110. An example of the structure of the insulating sheet 140 is described in detail below with reference to FIGS. 2 to 8.

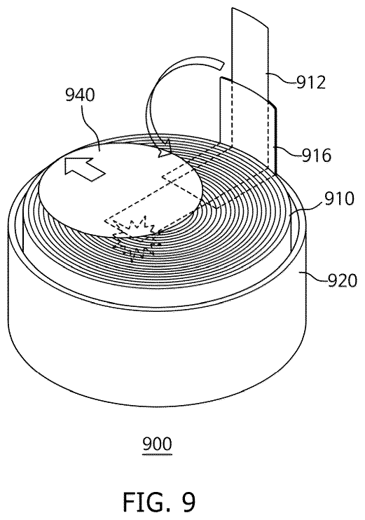

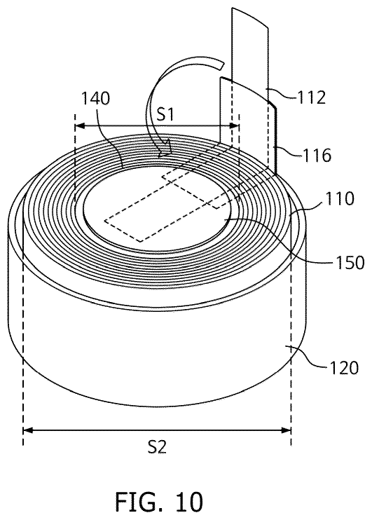

In an embodiment, the protrusion 144 may be inserted into the through hole formed in the core of the electrode assembly 110. In an implementation, the position of the insulating sheet 140 may be fixed on the electrode assembly 110. An example in which the position of the insulating sheet 140 is fixed on the electrode assembly 110 is described in detail below with reference to FIGS. 9 and 10.

The lithium metal layer 150 may be on the body portion 142 of the insulating sheet 140. The lithium metal layer 150 may be on the other surface of the body portion 142 opposite to one surface of the body portion 142 from which the protrusion 1440 may extend. In some embodiments, the lithium metal layer 150 may be on the other surface of the body portion 142 facing the cap assembly 130.

The lithium metal layer 150 may be connected to the first electrode tab 112. In a case where current is applied to the first electrode through the first electrode tab 112 during the charging process of the battery 100, lithium ions may be released from the lithium metal layer 150. The released lithium ions may move through the insulating sheet 140 and be stored inside the second electrode. In an embodiment, the insulating sheet 140 may include, e.g., a material having a porous structure. In an implementation, lithium ions may easily move through the pores of the insulating sheet 140.

Due to the above-described configuration, the pre-lithiation process of the battery 100 may be easily performed during the charging process of the battery 100. In an implementation, by simply applying current to the first electrode during the battery manufacturing step, lithium ions may be prestored inside the second electrode, thereby helping overcome the problem of initial irreversible capacity of active materials including silicon-based materials.

In an embodiment, the diameter of the protrusion 144 may be less than the diameter of the through hole of the electrode assembly 110. In an implementation, the vertical length of the protrusion 144 may be less than the vertical length of the through hole. The vertical direction may represent the height direction of the secondary battery.

In an embodiment, the diameter of the protrusion 144 may be substantially similar to the diameter of the through hole of the electrode assembly 110. That is, in a case where the protrusion 144 is inserted into the through hole of the electrode assembly 110, the protrusion 144 may be engaged with the through hole so that a space between the protrusion 144 and the inner surface of the electrode assembly 110 substantially does not exist. For example, the sides of the protrusion may touch the sides of the inner surface of the through hole. Accordingly, the protrusion 144 may be prevented from moving, e.g., from moving laterally, inside the through hole, thereby stabilizing the insulating sheet 140 relative to the electrode assembly 110.

Due to the above-described configuration, the protrusion 144 may be inserted into the through hole of the electrode assembly 110, and thus, the insulating sheet 140 may be fixed on the top surface of the electrode assembly 110. The insulating sheet 140 may be fixed so as not to move on the top surface of the electrode assembly 110. Due to this, even in a case where the battery 100 is dropped or external impact may be applied to the battery 100, the risk of damage to the insulating sheet 140 or a battery short circuit occurring due to movement of the insulating sheet 140 may be minimized.

In some embodiments, in a case where the insulating sheet 140 is on the top surface of the electrode assembly 110, the protrusion 144 may correspond to the through hole of the electrode assembly 110. Due to this, the insulating sheet 140 may be positioned so as not to be biased on the top surface of the electrode assembly 110.

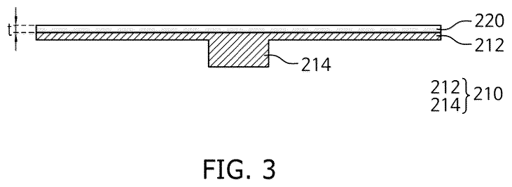

FIG. 2 illustrates a perspective view showing an example in which the lithium metal layer 220 is on the insulating sheet 210 according to an embodiment of the present disclosure, and FIG. 3 illustrates a cross-sectional view showing an example in which the lithium metal layer 220 is on the insulating sheet 210 according to an embodiment of the present disclosure. FIG. 3 illustrates a cross-sectional view showing a structure in which the insulating sheet 210 having an approximately disk shape is cut in the height direction along a line crossing the center of the insulating sheet 210.

The insulating sheet 210 may include, e.g., a body portion 212 and a protrusion 214 extending from one surface of the body portion 212 and inserted into a through hole of the electrode assembly. For convenience of description, the one surface of the body portion 212 from which the protrusion 214 extends is referred to as the bottom surface of the body portion 212, and the opposite surface thereof is referred to as the top surface of the body portion 212.

Referring to FIGS. 2 and 3, the body portion 212 may have an approximately disk shape, and the protrusion 214 may have an approximately cylindrical shape. The center of the protrusion 214 may correspond to the center of the body portion 212. In some embodiments, the diameter of the protrusion 214 may be less than the diameter of the body portion 212.

The lithium metal layer 220 may be on the top surface of the body portion 212. The lithium metal layer 220 may be bonded to the body portion 212 or may be fixed in position with tape or the like. In an implementation, in a state in which the lithium metal layer 220 may be on the top surface of the body portion 212, the position of the lithium metal layer 220 may be fixed by applying pressure in the vertical direction between the cap assembly above the lithium metal layer 220 and the electrode assembly below the body portion 212.

The lithium metal layer 220 may have an approximately disk shape. The diameter of the body portion 212 and the diameter of the lithium metal layer 220 may substantially correspond to each other. In an embodiment, the thickness t of the lithium metal layer 220 may be, e.g., 5 μm to 250 μm.

In an embodiment, lithium ions may be released through the lithium metal layer 220. In an implementation, in a case where current is applied to the lithium metal layer 220 through the first electrode tab connected to the lithium metal layer 220 during the charging process of the battery, lithium ions may be released from the lithium metal layer 220. Lithium ions released from the lithium metal layer 220 may be stored in the second electrode (e.g., negative electrode).

In an embodiment, the insulating sheet 210 may include, e.g., a material having a porous structure. In an implementation, the insulating sheet 210 may include plastic, e.g., polyethylene, polypropylene, or polyethylene, and may have a porous structure through, e.g., mechanical stretching, heat treatment, or the like. The pores inside the insulating sheet 210 may provide a space for movement of lithium ions released from the lithium metal layer 220.

With this configuration, lithium ions released from the lithium metal layer 220 may move through the insulating sheet 210. That is, even in a case where the insulating sheet 210 exists, lithium ions released from the lithium metal layer 220 above the insulating sheet 210 may pass through the insulating sheet 210 and smoothly move toward the electrode assembly below the insulating sheet 210.

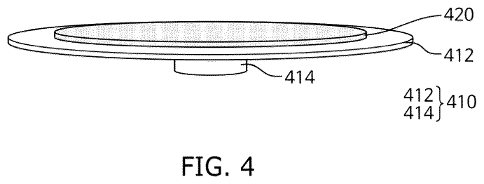

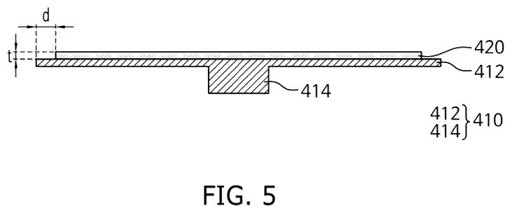

FIG. 4 illustrates a perspective view showing an example in which a lithium metal layer 420 is on an insulating sheet 410 according to another embodiment of the present disclosure, and FIG. 5 illustrates a cross-sectional view showing an example in which the lithium metal layer 420 is on the insulating sheet 410 according to another embodiment of the present disclosure. FIG. 5 illustrates a cross-sectional view showing a structure in which the insulating sheet 410 having an approximately disk shape is cut in the height direction along a line crossing the center of the insulating sheet 410. In FIGS. 4 and 5, configurations described above or redundant with those provided in FIGS. 1 to 3 are omitted.

The insulating sheet 410 may include, e.g., a body portion 412 and a protrusion 414 extending from one surface of the body portion 412. For convenience of description, the one surface of the body portion 412 from which the protrusion 414 extends is referred to as the bottom surface of the body portion 412, and the opposite surface thereof is referred to as the top surface of the body portion 412. The body portion 412 may have, e.g., an approximately disk shape.

The lithium metal layer 420 may be on the top surface of the body portion 412. The lithium metal layer 420 may have an approximately disk shape. The thickness t of the lithium metal layer 420 may be, e.g., 5 μm to 250 μm.

In an embodiment, the radius of the lithium metal layer 420 may be less than the radius of the insulating sheet 410. In an implementation, a radius difference d between the lithium metal layer 420 and the insulating sheet 410 may be, e.g., 100 μm or more.

With this configuration, the insulating sheet 410 may protrude outward from the lithium metal layer 420, thereby preventing the lithium metal layer 420 from coming into contact with the case. Accordingly, the case electrically connected to the second electrode (e.g., the negative electrode) may be prevented from coming into contact with the lithium metal layer 420 electrically connected to the first electrode (e.g., the positive electrode).

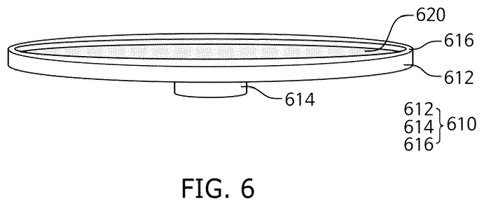

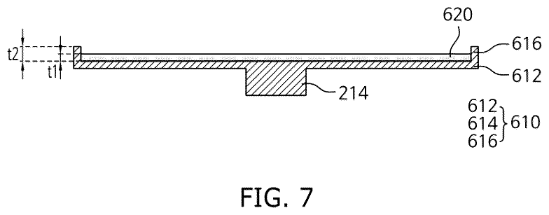

FIG. 6 illustrates a perspective view showing an example in which a lithium metal layer 620 is on an insulating sheet 610 according to another embodiment of the present disclosure, and FIG. 7 illustrates a cross-sectional view showing an example in which the lithium metal layer 620 is on the insulating sheet 610 according to another embodiment of the present disclosure. FIG. 7 illustrates a cross-sectional view showing a structure in which the insulating sheet 610 having an approximately disk shape is cut in the height direction along a line crossing the center of the insulating sheet 610. In FIGS. 6 and 7, configurations described above or redundant with those provided in FIGS. 1 to 5 are omitted.

The insulating sheet 610 may include, e.g., a body portion 612, a protrusion 614 extending from one surface of the body portion 612, and a sidewall portion 616 extending from the other surface of the body portion 612 facing one surface of the body portion 612. For convenience of description, the one surface of the body portion 612 from which the protrusion 614 extends is referred to as the bottom surface of the body portion 612, and the opposite surface thereof is referred to as the top surface of the body portion 612.

The lithium metal layer 620 may be on the top surface of the body portion 612. The lithium metal layer 620 may have an approximately disk shape. The thickness t of the lithium metal layer 620 may be, e.g., 5 μm to 250 μm.

The sidewall portion 616 of the insulating sheet 610 may extend along the top surface circumference of the body portion 612 and surround the lithium metal layer 620. The sidewall portion 616 may protrude more than the lithium metal layer 620 with respect to the thickness direction of the lithium metal layer 620. That is, the height t2 of the sidewall portion 616 may be greater than the thickness t1 of the lithium metal layer 620.

With this configuration, the sidewall portion 616 of the insulating sheet 610 may extend to protrude beyond the lithium metal layer 620 and surround the lithium metal layer 620, thereby preventing the lithium metal layer 620 from coming into contact with the case. In an implementation, the case electrically connected to the second electrode (e.g., the negative electrode) may be prevented from coming into contact with the lithium metal layer 620 electrically connected to the first electrode (e.g., the positive electrode).

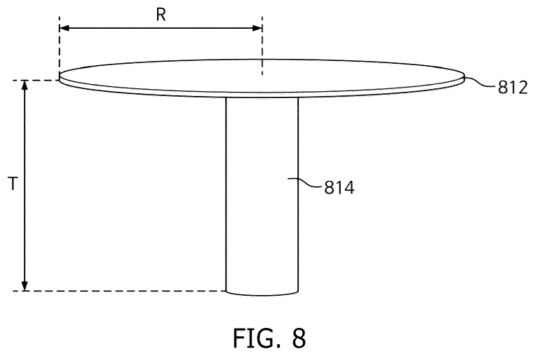

FIG. 8 illustrates a perspective view showing an insulating sheet according to an embodiment of the present disclosure. As shown in FIG. 8, the insulating sheet may include, e.g., a body portion 812 having a substantially disk shape and a protrusion 814 extending from one surface of the body portion 812. The protrusion 814 may have an approximately disk shape, and the center of the protrusion 814 may correspond to the center of the body portion 812.

In an embodiment, the insulating sheet may be on the electrode assembly and may insulate the electrode assembly and the cap assembly from each other. At this time, the body portion 812 of the insulating sheet may be on one surface of the electrode assembly, and the protrusion 814 of the insulating sheet may be inserted into the core of the electrode assembly.

In an embodiment, the vertical length T of the protrusion 814 may be less than or equal to the vertical length of the through hole of the electrode assembly. The vertical direction may refer to the direction in which the protrusion 814 extends from the body portion 812. In some embodiments, the radius R of the body portion 812 may be less than or equal to the radius of the electrode assembly (e.g., the distance from the core of the electrode assembly to the outermost surface). In some embodiments, the vertical length T of the protrusion 814 may be equal to or greater than the radius R of the body portion 812.

With this configuration, the vertical length T of the protrusion 814 may be ensured, e.g., surrounded, to a certain length or more. Accordingly, in a case where the protrusion 814 is inserted into the through hole of the electrode assembly, the position of the insulating sheet on the electrode assembly may be fixed. That is, even in a case where an external force is applied to the insulating sheet, the possibility of movement of the insulating sheet is reduced.

FIG. 9 illustrates an example of a battery 900 in which an insulating sheet 940 is positioned according to a comparative example. The battery 900 according to the comparative example may include, e.g., an electrode assembly 910, a case 920 that accommodates the electrode assembly 910, and an insulating sheet 940 on one surface of the electrode assembly 910. For convenience of description, one surface of the electrode assembly 910 on which the insulating sheet 940 may be on may be referred to as the top surface of the electrode assembly 910. In an implementation, the one surface of the insulating sheet 940 facing the top surface of the electrode assembly 910 may be referred to as the bottom surface of the insulating sheet 940, and the opposite surface thereof may be referred to as the top surface of the insulating sheet 940.

As shown, the insulating sheet 940 may be on the top surface of the electrode assembly 910. The electrode assembly 910 may include a first electrode (e.g., a positive electrode), and the first electrode may be connected to an electrode tab 912. The electrode tab 912 may protrude from the top surface of the electrode assembly 910. The electrode tab 912 may be bent toward the insulating sheet 940 on the top surface of the electrode assembly 910. Cover tapes 916 may be attached to opposite surfaces of the electrode tab 912. The cover tape 916 may help insulate between the electrode tab 912 and the top surface of the electrode assembly 910 and/or between the electrode tab 912 and the cap assembly.

The insulating sheet 940 according to the comparative example may not have a protrusion extending from the bottom surface of the insulating sheet 940. That is, the insulating sheet 940 may include, e.g., only a disk-shaped body portion. In this case, the position of the insulating sheet 940 may not be fixed on the electrode assembly 910. In some embodiments, in a state in which the insulating sheet 940 is on the electrode assembly 910, the center of the insulating sheet 940 and the center of the electrode assembly 910 may not correspond to each other. Due to this, the electrode tab 912 may come into contact with the electrode assembly 910, causing a short circuit to occur between the electrode tab 912 and the electrode assembly 910.

In some embodiments, in order for pre-lithiation of the battery 900, in a case where a lithium metal layer is on the top surface of an insulating sheet 940 and the electrode tab 912 may be connected to the lithium metal layer, as the insulating sheet 940 is moved inside the battery, the connection between the lithium metal layer on the top surface of the insulating sheet 940 and the electrode tab 912 may be broken.

FIG. 10 illustrates an example of an electrode assembly 110 in which an insulating sheet 140 is positioned according to an embodiment of the present disclosure. The battery described with reference to FIG. 10 may be understood based on the description provided with reference to FIG. 1. The battery may include, e.g., an electrode assembly 110, a case 120 that accommodates the electrode assembly 110, an insulating sheet 140 on one surface of the electrode assembly 110, and a lithium metal layer 150 on one surface of the insulating sheet 140. For convenience of description, the one surface of the electrode assembly 110 on which the insulating sheet 140 is positioned may be referred to as the top surface of the electrode assembly 110. In addition, the one surface of the insulating sheet 140 facing the top surface of the electrode assembly 110 may be referred to as the bottom surface of the insulating sheet 140, and the opposite surface thereof may be referred to as the top surface of the insulating sheet 140.

The insulating sheet 140 may include, e.g., a body portion and a protrusion extending from the body portion. The protrusion may be inserted into a through hole formed in the core of the electrode assembly 110. Due to this, the position of the insulating sheet 140 may be fixed on the electrode assembly 110.

In an embodiment, the diameter S1 of the body portion of the insulating sheet 140 may be less than the diameter S2 of the electrode assembly 110. The insulating sheet 140 may cover a portion of the top surface of the electrode assembly 110. By reducing the diameter S1 of the body portion of the insulating sheet 140, the cost for manufacturing the insulating sheet 140 may be reduced.

After the insulating sheet 140 is on the electrode assembly 110, the first electrode tab 112 may be bent toward the insulating sheet 140. Because the diameter S1 of the body portion of the insulating sheet 140 may be formed to be less than the diameter S2 of the electrode assembly 110, there may be a risk that a portion of the first electrode tab 112 where the cover tape 116 is not attached may come into contact with a portion of the top surface of the electrode assembly 110. However, because the protrusion of the insulating sheet 140 may be inserted into the through hole of the electrode assembly 110 and the position of the insulating sheet 140 may be fixed on the electrode assembly 110, a short circuit may not occur between the first electrode tab 112 and the electrode assembly 110. That is, even in a case where the diameter S1 of the body portion of the insulating sheet 140 is formed to be small, the insulating sheet 140 may cover a portion of the top surface of the electrode assembly and the cover tape 116 may protect a portion of the first electrode tab 112. Accordingly, a short circuit may not occur between the first electrode tab 112 and the electrode assembly 110.

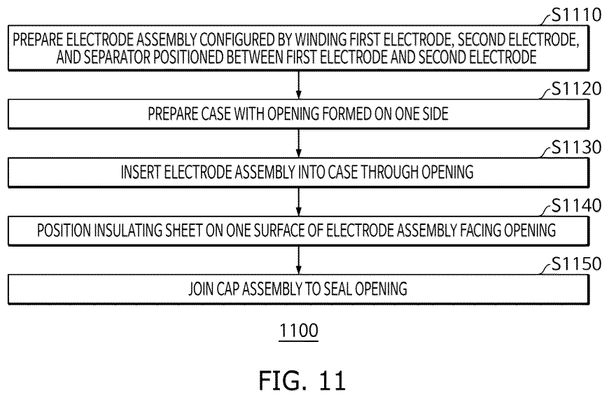

FIG. 11 illustrates a flowchart for describing a method 1100 of manufacturing a battery according to an embodiment of the present disclosure. The method 1100 of manufacturing the battery may be initiated by preparing an electrode assembly configured by winding a first electrode, a second electrode, and a separator, the separator positioned between the first electrode and the second electrode (S1110). The electrode assembly may include a through hole in a core thereof. In some embodiments, the first electrode may be connected to an electrode tab. Additionally, the second electrode may include, e.g., an active material layer including a silicon-based material.

Thereafter, a case with an opening formed on one side may be prepared (S1120). Next, the electrode assembly may be inserted into the case through the opening of the case (S1130).

Thereafter, an insulating sheet may be positioned on one surface of the electrode assembly facing the opening of the case (S1140). A lithium metal layer may be positioned on one surface of the insulating sheet. In an implementation, the insulating sheet may include, e.g., a body portion having a lithium metal layer on one surface and a protrusion extending from the other surface of the body portion opposite to the one surface. In an implementation, the protrusion of the insulating sheet may be inserted into the through hole of the electrode assembly. Because the protrusion is inserted into the through hole, the insulating sheet may be fixed on the electrode assembly.

In an embodiment, the diameter of the protrusion of the insulating sheet may be less than the diameter of the through hole of the electrode assembly. In some embodiments, the vertical length of the protrusion of the insulating sheet may be less than the vertical length of the through hole of the electrode assembly.

In an embodiment, the radius of the lithium metal layer may be less than the radius of the insulating sheet. In an implementation, the radius difference between the lithium metal layer and the insulating sheet may be, e.g., 100 μm or more.

In an embodiment, the insulating sheet may further include a sidewall portion extending from the body portion. In an implementation, the sidewall portion may extend along the circumference of one surface of the body portion on which the lithium metal layer is positioned, thereby surrounding the lithium metal layer. At this time, the sidewall portion may protrude more than the lithium metal layer with respect to the thickness direction of the lithium metal layer. The thickness of the lithium metal layer may be, e.g., 5 μm to 250 μm.

Thereafter, a cap assembly may be joined to seal the opening of the case (S1150). Accordingly, the lithium metal layer positioned on one surface of the insulating sheet may face the cap assembly.

Thereafter, current may be applied to the first electrode. At this time, in a case where current is applied to the first electrode, lithium ions may be released from the lithium metal layer. In an embodiment, the insulating sheet may include, e.g., a material having a porous structure. Accordingly, lithium ions released from the lithium metal layer may move through the insulating sheet. In some embodiments, the released lithium ions may be stored inside the second electrode.

The flowchart of FIG. 11 and the above description are only examples of the present disclosure. In an implementation, one or more steps in the flowchart and the above description may be added/changed/deleted, the order of one or more steps may be changed, and one or more steps may be performed simultaneously.

By way of summation and review, carbon-based materials such as graphite may be used as the negative electrode of the lithium secondary battery. However, recently, a method of using silicon-based materials such as silicon (Si) oxide and silicon alloys that are alloyed with lithium as negative electrode active materials is being considered to improve the energy density of the negative electrode. However, silicon-based materials may have a reduced mechanical stability due to volume changes that occur during the intercalation/deintercalation process of lithium ions, which may result in an increase in the initial irreversible capacity and deterioration of the cycle characteristics of the battery.

Embodiments of the present disclosure provide a battery and a method of manufacturing the battery.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery, comprising:
a wound electrode assembly including a first electrode, a second electrode, and a separator between the first electrode and the second electrode;
a case accommodating the electrode assembly;
the case including an opening on one side;
a cap assembly sealing the opening;
an insulating sheet between the cap assembly and the electrode assembly; and
a lithium metal layer on the insulating sheet facing the cap assembly.

2. The battery as claimed in claim 1, further comprising an electrode tab connecting the first electrode to the lithium metal layer.

3. The battery as claimed in claim 2, wherein the battery is configured so that lithium ions are released from the lithium metal layer when an electrical current is applied to the first electrode.

4. The battery as claimed in claim 3, wherein the battery is configured so that the released lithium ions are stored inside the second electrode.

5. The battery as claimed in claim 4, wherein:
the insulating sheet includes a material having a porous structure, and
the battery is configured so that the released lithium ions move through the insulating sheet.

6. The battery as claimed in claim 1, wherein the insulating sheet includes a body portion having a first surface and a second surface in opposing configuration, the lithium metal layer being on the first surface and a protrusion extending from the second surface.

7. The battery as claimed in claim 6, wherein:
the electrode assembly includes a through hole in a core thereof, and
the protrusion extends into the through hole.

8. The battery as claimed in claim 7, wherein the protrusion stabilizes the insulating sheet relative to the electrode assembly.

9. The battery as claimed in claim 7, wherein a diameter of the protrusion is less than a diameter of the through hole.

10. The battery as claimed in claim 7, wherein a vertical length of the protrusion is less than a vertical length of the through hole.

11. The battery as claimed in claim 1, wherein a radius of the lithium metal layer is less than a radius of the insulating sheet.

12. The battery as claimed in claim 11, wherein a radius difference between the lithium metal layer and the insulating sheet is 100 μm or more.

13. The battery as claimed in claim 1, wherein the insulating sheet includes:
a body portion having the lithium metal layer on a surface thereof, and
a sidewall portion extending along an outer circumference of the body portion and surrounding the lithium metal layer.

14. The battery as claimed in claim 13, wherein the sidewall portion extends above the lithium metal layer.

15. The battery as claimed in claim 1, wherein a thickness of the lithium metal layer is 5 μm to 250 μm.

16. The battery as claimed in claim 1, wherein the second electrode includes an active material layer including a silicon-based material.

17. A method of manufacturing a battery, the method comprising:
preparing an electrode assembly by winding a first electrode, a second electrode, and a separator, the separator being between the first electrode and the second electrode;
preparing a case with an opening formed on one side thereof;
inserting the electrode assembly into the case through the opening;
positioning an insulating sheet on one side of the electrode assembly, the one side of the electrode assembly facing the opening; and
sealing the opening by joining a cap assembly to the case,
wherein a lithium metal layer is positioned on a surface of the insulating sheet facing the cap assembly.

18. The method as claimed in claim 17, the method further including connecting the first electrode to the lithium metal layer using an electrode tab and thereafter sealing the opening.

19. The method as claimed in claim 18, wherein after sealing the opening, an electrical current is applied to the first electrode to release lithium ions from the lithium metal layer.

20. The method as claimed in claim 17, further including:
providing the insulating sheet with a body portion having a first surface and a second surface in opposing configuration, providing the lithium metal layer on the first surface, and providing a protrusion extending from the second surface,
providing the electrode assembly with a core having a through hole,
providing a through hole in a core of the electrode assembly, and
inserting the protrusion into the through hole.
